(19) United States
(12) Patent Application Publication
(10) Pub. No.: US 2007/0189147 A1
(43) Pub. Date: Aug. 16, 2007

(54) Optical recording medium, evaluation method therefor, information reproduction method, and information recording method

(76) Inventors: Harukazu Miyamoto, Higashimurayama (JP); Akemi Hirotsune, Saitama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/492,791

(22) Filed: Jul. 26, 2006

(30) Foreign Application Priority Data
Feb. 14, 2006 (JP) 2006-035905

(51) Int. Cl. G11B 7/24

(52) U.S. Cl. 369/275.1; 369/275.4; 369/94

(57) ABSTRACT

Multilayered optical recording media having three or more recording layers used to require spacing between recording layers to be accurately controlled to cope with the effect of crosstalk attributable to multiple reflections at plural recording layers. Making reflectivity at a backside of each recording layer lower than reflectivity at a front side thereof can reduce the effect of multiple reflections without requiring technology for highly accurately controlling interlayer spacing, so that medium production cost can be greatly reduced.

### CLAIM OF PRIORITY

The present application claims priority from Japanese application JP 2006-035905 filed on Feb. 14, 2006, the content of which is hereby incorporated by reference into this application.

### FIELD OF THE INVENTION

The present invention relates to a method for evaluating an optical recording medium having plural recording layers and interlayer crosstalk on such an optical recording medium.

### BACKGROUND OF THE INVENTION

FIG. 2 is a schematic diagram showing a cross-sectional structure of a prior-art multilayered optical disc and a principle of selectively recording or reproducing information on or from a recording layer. In the prior-art example, the recording medium comprises a total of five recording layers, that is, a first recording layer 411, a second recording layer 412, a third recording layer 413, a fourth recording layer 414, and a fifth recording layer 415. To access information recorded, for example, on the second recording layer 412 of the five-layered medium, an optical spot 32 is positioned on the second recording layer 412 by controlling the position of an objective lens 30. During the process, convergent light 31 under control of the objective lens 30 penetrates through the semitransparent recording layer 411. The beam diameter on the first recording layer 411 of the convergent light 31 is, however, much larger than the diameter of the optical spot 32 on the second recording layer 412, so that the convergent light 31 cannot optically resolve and reproduce information recorded on the semitransparent first recording layer 411. On the semitransparent first recording layer 411, as the beam diameter is large, the light intensity per unit area is relatively small. Therefore, recording information on the second recording layer 412 does not cause information recorded on the first recording layer 411 to be destroyed. Thus, information can be recorded on and reproduced from the second recording layer 412 without being affected by the first recording layer 411.

Similarly, when recording or reproducing information on or from the fifth recording layer 415, the optical spot 32 is positioned on the fifth recording layer 415 by controlling the position of the objective lens 30. At this time, the beam diameter on the layer adjacent to the target layer is given by:

L*NA/(1−NÂ2)̂(½)

where L is spacing between layers, NA is the numerical aperture of the objective lens, λ is the wavelength, and the operator “̂” means; X̂Y denotes X to the Yth power. For example, when L=5 μm and NA=0.85, the beam diameter is 8 μm. Since, when the wavelength λ is 400 nm, the diameter of the optical spot 32 on the target layer is 480 nm (given by λ/NA), the beam diameter of 8 μm is about 17 times the optical spot diameter. That is, the beam area is about 300 times the optical spot area. The conditions for recording and reproducing information on and from a recording layer of an optical recording medium having plural recording layers without being affected by other recording layers are described in detail in JP 1993 (Hei 5)-101398 A (corresponding to U.S. Pat. No. 5,414,451).

How to design the reflectivity and transmittance of each layer of a multilayered optical disc like the one described above is disclosed in Japanese Patent Laid-Open No. 016208/H11 (1999). According to the method disclosed therein, a multilayered information recording medium having three or more information recording layers is to be designed to satisfy the following expression:

Rn−1≈Rn×(1−an−1−Rn−1)̂2

where Rn and an are the reflectivity and absorptance, respectively, of the nth recording layer from the incident side on which light for reading information emitted from a pickup is incident, and Rn−1 is the reflectivity of the n−1th recording layer from the incident side. The “(1−an−1−Rn−1)” represents the transmittance of the layer n−1. According to the above expression, therefore, the amount of light reflected from the n−1th layer is approximately equal to the amount of light which returns to a pickup after penetrating through the n−1th layer, being reflected from the nth layer, and again penetrating through the n−1th layer. Namely, designing is made such that the effective reflectance of light which is emitted from a pickup, reaches a layer, and returns to the pickup is approximately the same on every layer. This is achieved by making the reflectance of layers farther from the incident side higher so as to make up for the attenuation of light intensity caused by reflection and absorption at layers closer to the light incident side.

JP 2005-38463 A (corresponding to US2005/0013236) discloses a method in which film is made thicker for recording layers farther from the light incident side so as to approximately equalize the amount of light reflected from each recording layer (paragraph 0121) and also in which the refraction index of a disc sheet and that of the corresponding adhesive layer are approximately equalized. In the patent document, however, attention is not focused on the reflectivities of backsides of recording layers.

### SUMMARY OF THE INVENTION

Whereas the method for designing a multilayered optical recording medium takes into consideration the effect of light attenuation at layers which are closer to the light incident side than a layer targeted for information recording or reproduction, it gives no consideration to multiple reflections occurring at the layers closer to the light incident side. Problems caused by such multiple reflections will be described in the following with reference to FIG. 4. Now, assume that the nth layer is the target layer for information recording and reproduction. As shown in FIG. 4, the convergent light 31 is emitted on the nth layer so that the optical spot 32 is formed thereon. The light reflected from the n−1th layer directly preceding the target layer becomes unwanted light, and reaches the backside of the n−2th layer to be reflected from the backside thereof. The unwanted light thus reflected from the backside of the n−2th layer is reflected again from the n−1th layer, and returns to the optical pickup through a path approximately the same as the path followed by the light reflected from the nth layer, thereby causing large crosstalk. Returning of such unwanted light to the optical pickup is quite problematical.

Firstly, the unwanted light converges on the n−2th layer to form an unwanted optical spot, so that it can optically resolve information recorded on the n−2th layer. The signal generated by the unwanted optical spot cannot be isolated, since it overlaps in frequency band with a normal optically-reproduced signal.

Secondly, as the path followed by the unwanted light returning to the optical pickup is approximately the same as the path followed by the light reflected from the nth layer, the unwanted light and the light reflected from the nth layer follow a same path inside the optical pickup, too. As a result, they completely overlap with each other on the detector.

Thirdly, when the unwanted light reaching the detector cannot be isolated, it is difficult to quantitatively evaluate the amount of crosstalk caused by the unwanted light.

The bad effect of multiple-reflected unwanted light, i.e. the problem of crosstalk is attributable to uniform spacing between layers. In this regard, a method in which layers are spaced unevenly is disclosed, for example, in Japanese Journal of Applied Physics, Vol. 43, No. 7B, 2004, pp. 4983-4986. In the example described in the document, four layers are arranged with spacings of 15 μm, 17 μm, and 13 μm, thereby preventing multiple-reflected unwanted light from following a same return path.

There are, however, problems with the method. According to the method, differences between the interlayer spacings are only about 2 μm, so that the difference in size between the unwanted optical spot and the required optical spot is small. In such a state, the effect of crosstalk cannot be reduced. Furthermore, if an error of even 1 μm in spacing between layers results from manufacturing variations, the crosstalk due to unwanted light sharply increases. To put it conversely, it is necessary to manufacture media with very high accuracy without little variations. This results in an increase in media production cost. A still another problem is that, to secure a spacing margin required to provide uneven spacings between layers, it is necessary to make the spacings between layers larger than for an ordinary two-layered medium. This eventually makes it difficult to increase the number of layers per medium.

A first object of the present invention is to provide a multilayered optical recording medium having multiple recording layers, while suppressing the effect of interlayer crosstalk occurring when the medium has three or more recording layers, without inviting an increase in production cost.

A second object of the present invention is to provide an optical recording medium which enables the effect of interlayer crosstalk occurring when the medium has three or more recording layers to be quantitatively evaluated.

To achieve the first object of the present invention, the following means are used:

(1) In a multilayered recording medium having three or more recording layers, the optical reflectivity of each recording layer is made smaller at the backside thereof than at the front side thereof as viewed from the side on which light for recording or reproducing is incident.

In a multilayered medium in which multiple reflections occur, the above means can reduce the effect of reflections from backsides of layers, so that interlayer crosstalk can be reduced. With reference to FIG. 4, this means that the reflectivity Rₙ₋₂ back of the n−2th layer is reduced, so that the amount of unwanted light returning to the optical head after being reflected from the backside of the n−2th layer can be reduced.

### (2) The optical reflectivity of every recording layer excluding the two layers farthest from the incident side is made smaller at the backside thereof than at the front side thereof.

This can reduce the effect of crosstalk attributable to all the multiple reflections occurring at plural layers. As a result, the quality of signal reproduced from a target layer improves.

(3) In a multilayered optical recording medium having three or more recording layers, the product of the optical reflectivity at the backside of a first recording layer and the optical reflectivity at the front side of a second recording layer is made 0.0025 or smaller, the first recording layer being one of any two adjacent recording layers excluding the one farthest from the light incident side and being closer to the light incident side than the other of the two adjacent recording layers, and the second recording layer being the other of the two adjacent recording layers.

In FIG. 4, the n−2th layer is the first recording layer, and the n−1th layer is the second recording layer. The crosstalk light resulting from multiple reflections is the light that returns to the optical pickup after being reflected first from the front side of the n−1th layer, next from the backside of the n−2th layer, and then again from the front side of the n−1th layer. The signal light is the light that returns to the pickup after penetrating through the n−1th layer and then being reflected from the front side of the nth layer. From a viewpoint of equalizing the intensity of reproduction output, as described above with reference to Japanese Patent Laid-Open No. 016208/H11 (1999), the intensity of the signal light from the nth layer is approximately equalized with the amount of signal light obtained when the optical spot is positioned on the n−1th layer, i.e. the intensity of light reflected from the front side of the n−1th layer. Therefore, the intensity of the signal light obtained from the nth layer is proportional to the reflectivity of the front side of the n−1th layer, and the amount of crosstalk light is approximately equal to the product of the square of the reflectivity of the front side of the n−1th layer and the reflectivity of the backside of the n−2th layer. Since the reflectivity of the front side of the n−1th layer is common to the crosstalk light and the signal light, the proportion of the crosstalk light to the signal light is equal to the reflectivity of the front side of the n−1th layer multiplied by the reflectivity of the backside of the n−2th layer, i.e. the product of the reflectivity of the backside of the first recording layer and the reflectivity of the front side of the second recording layer. The effect of interlayer crosstalk caused by multiple reflections on reproduction quality can be reduced by keeping the above proportion to about 0.0025, i.e. the square of 1/20, the value 1/20 being about one half of the proportion of a minimum amplitude to a maximum amplitude of ordinary signal light.

### (4) The above product of the optical reflectivities is made 0.001 or smaller.

This can reduce the amount of relative crosstalk to or below (0.001)̂(½)≈1/30, even with the effect of wave optical interference between the crosstalk light and the signal light taken into consideration.

(5) Relative to a signal output detected by the light reflected from a recording layer where a focal optical spot is positioned, the proportion of a maximum crosstalk from the recording layer detected at a location which is at least 1 μm apart from the recording layer and to which the focal optical spot has been moved is made 0.0025 or smaller, or more preferably, 0.001 or smaller.

Since the signal from the recording layer and the signal from another layer obtained when the optical spot is positioned on the another layer are approximately of a same level, the amount of crosstalk of the signal from the recording layer affecting the another layer approximately corresponds to the proportion of crosstalk to the signal on the another layer. Hence, effects similar to those of the foregoing means (3) and (4) can be obtained.

(6) When a focal optical spot is moved on a medium having an area where different signals are recorded on different recording layers, relative to a maximum intensity of a signal on any of the recording layers, the proportion of a second peak output of the signal detected at a location to which the focal optical spot has been moved from the any of the recording layers is made 0.0025 or smaller, or more preferably 0.001 or smaller.

Since the proportion of the second peak output is equal to the proportion of the crosstalk mentioned in (5) above, effects similar to those of the means (3) and (5) can be obtained. Furthermore, since different signals are recorded on different recording layers, the amount of crosstalk from each layer can be isolated and detected with ease.

### (7) Signals differing from one another in frequency are used as the different signals recorded on the different recording layers.

This enables the effect, i.e. crosstalk, from each recording layer to be isolated and detected with ease using a bandpass filter or a spectrum analyzer.

### (8) Wobble signals formed in grooves or in series of pits are used as the signals recorded on the recording layers.

The wobble signals can be commonly used also to represent address information, or they can be superimposed with wobble signals for address information. This makes it possible to detect the wobble signals as differential signal output. The differential signal output enables layer identification when detecting a signal from a specific layer, without requiring any additional area to be used. Thus, the means realizes high data efficiency. It also enables an unrecorded medium to be put in use without requiring any pre-writing. Furthermore, using such wobble signals does not exert any bad effect on data recorded on the medium.

(9) When a focal optical spot is moved on a medium having an area where a signal is recorded on only one recording layer with no signal recorded on the other recording layers, relative to a maximum intensity of a signal on the one recording layer, the proportion of a second peak output of the signal detected at a location to which the focal optical spot has been moved from the one recording layer is made 0.0025 or smaller, or more preferably 0.001 or smaller.

This makes it possible to accurately measure an interlayer crosstalk characteristic of a target layer without being affected by signals recorded on other layers. By making the measured crosstalk adequately small, effects similar to those of the means (3), (5), and (6) can be obtained.

To achieve the second object of the present invention, the following means are used:

(10) A method is used to determine the amount of crosstalk from each recording layer of an optical recording medium having plural recording layers, the method comprising: pre-recording a signal with a constant frequency on each of the plural recording layers, the constant frequency being different between the plural recording layers; isolating and detecting a frequency signal component from each of the plural recording layers; moving a focal optical spot across the plural recording layers; and measuring the proportion, relative to a maximum intensity of the frequency signal component of each of the plural recording layers, of a sub-peak output. This makes it possible to accurately measure and compare the amount of crosstalk from each layer of a recording medium having plural layers without being affected by other layers. This measurement method enables recording and reproducing characteristics of a medium to be accurately prescribed, and consequently serves to provide high-quality optical recording media.

As shown in FIG. 12, according to the present invention, a stable and good recording and reproducing characteristic (low jitter) can be obtained without requiring interlayer spacing to be accurately controlled. Namely, the present invention allows the use of an economical production process such as a spin coat method which tends to cause variations in interlayer spacing, so that it can provide high-quality multilayered recording media at low cost. Since, according to the present invention, it is not necessary to secure any extra margin between layers, six or more recording layers can be provided in a medium with a spherical aberration correction range of about 25 μm which is comparable to that of a currently available optical disc compatible with blue light. Hence, it is possible to realize a recording capacity of 150 GB or more.

### BRIEF DESCRIPTION OF THE DRAWINGS

FIG. 1 is a schematic diagram showing a cross-sectional structure of a multilayered recording medium according to the present invention;

FIG. 2 is a diagram showing a structure of a prior-art multilayered recording medium and a principle of recording or reproducing information on or from a layer independently of other layers;

FIG. 3 shows an example of a multilayer recording and reproducing device;

FIG. 4 is a diagram illustrating problems with a prior-art multilayered recording medium;

FIG. 5 shows an example of a stacked layer structure of an optical recording medium according to an embodiment of the present invention;

FIGS. 6A and 6B show an embodiment of multiple layer identification signals recorded on an optical information recording medium according to the present invention, FIG. 6A showing an identification signal recording area on the medium, and FIG. 6B showing layer identification signals;

FIGS. 7A and 7B show an example arrangement of multiple-layer identifying areas recorded on an optical information recording medium according to the present invention, FIG. 7A showing an arrangement of areas where layer identification signals are recorded on the medium, and FIG. 7B showing an arrangement of identification signals on each layer relative to other layers;

FIG. 8 shows an example of an optical head configuration according to an embodiment of the present invention;

FIG. 9 is a block diagram of a signal evaluation system for a multilayered information recording medium according to the present invention;

FIG. 10 shows an example comparison of crosstalk evaluation results on a multilayered information recording medium;

FIG. 11 is a diagram showing a relationship between relative intensity of crosstalk and reproduction jitter; and

FIG. 12 is a diagram comparing an optical recording medium according to the present invention and a prior-art multilayered recording medium in terms of reproduction jitter variations due to variances in interlayer distance.

### DETAILED DESCRIPTION OF THE PREFERRED EMBODIMENTS

### First Embodiment

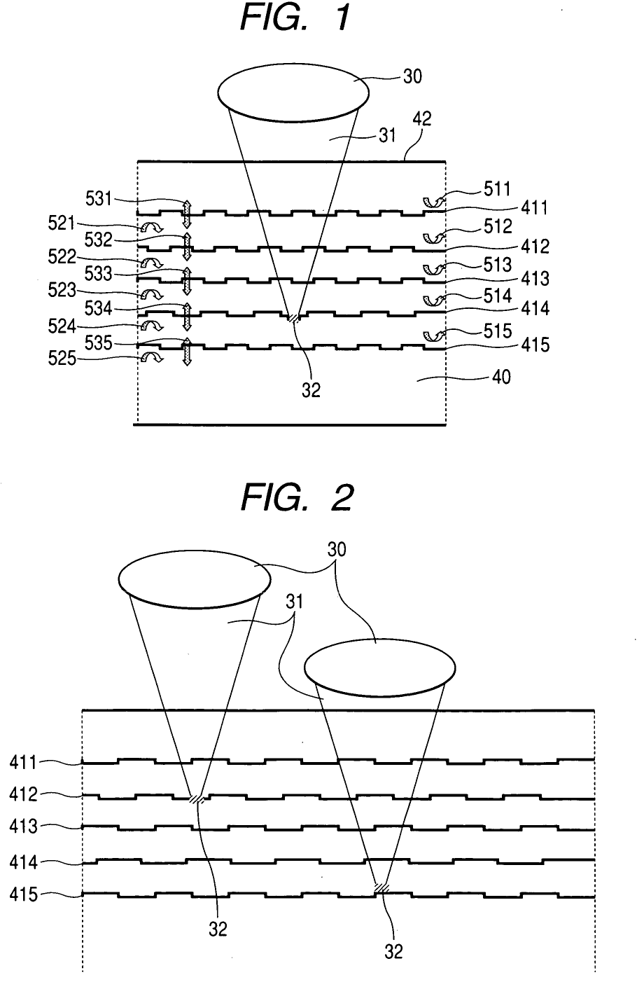

FIG. 1 is a schematic diagram showing a cross-sectional structure of a recording medium according to a first embodiment of the present invention. A recording medium 4 comprises a total of five recording layers stacked on a substrate 40. The five recording layers are a first recording layer 411, a second recording layer 412, a third recording layer 413, a fourth recording layer 414, and a fifth recording layer 415. The spacing between layers is about 6 μm. A cover layer with a thickness of about 70 μm is formed over the five recording layers. Convergent light 31 is emitted upon a light incident side 42, forming an optical spot 32 on one of the recording layers. At each recording layer, the reflectivity from the incident side 51 differs from the reflectivity from the backside 52. In FIG. 1, the reflectivities of the incident sides of the first to the fifth recording layers are denoted by reference numerals 511 to 515, respectively, and the reflectivities of the backsides of the first to the fifth recording layers are denoted by reference numerals 521 to 525, respectively. The optical transmittances of the first to the fifth recording layers are denoted by reference numerals 531 to 535, respectively.

Table 1 shows example reflectivities and transmittances designed for the recording layers of a multilayered optical recording medium.

TABLE 1

| | | | | | Effective |
|---|---|---|---|---|---|
| | Reflectivity | Reflectivity | | Two-way | (composite) |
| | from the | from the | Transmittance | transparency | reflectivity at |
| | incident side 51 | backside 52 | 53 | to the layer | the layer |
| The 1st | 6.0% | 0.5% | 84.0% | 100.0% | 6.0% |
| recording | | | | | |
| layer 411 | | | | | |
| The 2nd | 8.5% | 0.8% | 81.0% | 70.6% | 6.0% |
| recording | | | | | |
| layer 412 | | | | | |
| The 3rd | 13.0% | 0.4% | 75.0% | 46.3% | 6.0% |
| recording | | | | | |
| layer 413 | | | | | |
| The 4th | 23.0% | 23.0% | 66.0% | 26.0% | 6.0% |
| recording | | | | | |
| layer 414 | | | | | |
| The 5th | 53.0% | 53.0% | 0.0% | 11.3% | 6.0% |
| recording | | | | | |
| layer 415 | | | | | |

In the present embodiment, the effective reflectivity (excluding the effect of the light incident side 42) at the optical head is designed to be about 6%. Based on this, Table 2 shows, for each of the third to the fifth recording layers, the effective reflectivity of light returning to the optical head after being reflected at the backside of the upper (toward the light incident side) second recording layer, the intensity proportion of the returning light (crosstalk ratio) relative to the signal light, and the effect of interference with optical wave interference taken into consideration.

TABLE 2

| | Reflectivity of | | | |
|---|---|---|---|---|
| | unwanted light | | | |
| | at the backside | | | Effect of |
| | of upper | Crosstalk | Effect of | interference |
| | second layer | ratio | interference | (dB) |
| The 1st | — | — | — | — |
| recording | | | | |
| layer 411 | | | | |
| The 2nd | — | — | — | — |
| recording | | | | |
| layer 412 | | | | |
| The 3rd | 0.0025% | 0.04% | 2.06% | −33.7 |
| recording | | | | |
| layer 413 | | | | |
| The 4th | 0.0063% | 0.10% | 3.23% | −29.8 |
| recording | | | | |
| layer 414 | | | | |
| The 5th | 0.0055% | 0.09% | 3.03% | −30.4 |
| recording | | | | |
| layer 415 | | | | |

As shown, crosstalk intensity ratios of 0.10% or less have been obtained. When the interlayer spacings are approximately uniform, optical wavefronts of crosstalk light from different layers approximately coincide to bring about very strong interference. The optical interference like this is not optical energy interference but interference between electromagnetic wave amplitudes. Hence, the square root of the amplitude ratio represents an effect of crosstalk with interference taken into consideration. In Table 2, the effect of crosstalk with interference taken into consideration is shown as the effect of interference. In the present embodiment, the effect of crosstalk even with interference taken into consideration is about 3.2% (about −30 dB) or less. The value is small enough for practical purposes. In conventional cases in which the reflectivity of each recording layer is the same between the incident side and the backside, the effect is great as shown in Tables 3 and 4. Namely, the crosstalk intensity ratio reaches about 3% and the effect of interference about 17% (−15 dB).

TABLE 3

| | | | | | Effective |
|---|---|---|---|---|---|
| | Reflectivity | Reflectivity | | Two-way | (composite) |
| | from the | from the | Transmittance | transparency | reflectivity at |
| | incident side 51 | backside 52 | 53 | to the layer | the layer |
| The 1st | 6.0% | 6.0% | 84.0% | 100.0% | 6.0% |
| recording | | | | | |
| layer 411 | | | | | |
| The 2nd | 8.5% | 8.5% | 81.0% | 70.6% | 6.0% |
| recording | | | | | |
| layer 412 | | | | | |
| The 3rd | 13.0% | 13.0% | 75.0% | 46.3% | 6.0% |
| recording | | | | | |
| layer 413 | | | | | |
| The 4th | 23.0% | 23.0% | 66.0% | 26.0% | 6.0% |
| recording | | | | | |
| layer 414 | | | | | |
| The 5th | 53.0% | 53.0% | 0.0% | 11.3% | 6.0% |
| recording | | | | | |
| layer 415 | | | | | |

TABLE 4

| | Reflectivity of | | | |
|---|---|---|---|---|
| | unwanted light | | | |
| | at the backside | | | Effect of |
| | of upper | Crosstalk | Effect of | interference |
| | second layer | ratio | interference | (dB) |
| The 1st | — | — | — | — |
| recording | | | | |
| layer 411 | | | | |
| The 2nd | — | — | — | — |
| recording | | | | |
| layer 412 | | | | |
| The 3rd | 0.0306% | 0.51% | 7.13% | −22.9 |
| recording | | | | |
| layer 413 | | | | |
| The 4th | 0.0665% | 1.11% | 10.54% | −19.5 |
| recording | | | | |
| layer 414 | | | | |
| The 5th | 0.1791% | 2.98% | 17.26% | −15.3 |
| recording | | | | |
| layer 415 | | | | |

In the case of signals reproduced from an ordinary optical disc, the proportion of a minimum signal amplitude to a maximum signal amplitude (resolution) is about 10%. The effect of influence, therefore, exceeds the minimum signal amplitude proportion, so that, virtually, signal reproduction is not possible.

As described above, according to the present invention, the effect of reflection from backsides of layers in a multilayered optical recording medium can be held small enough for practical purposes.

### Second Embodiment

FIG. 5 is a schematic diagram showing a cross-sectional structure of a read-only type recording medium having six layers according to a second embodiment of the present invention. A recording medium 4 comprises a total of six recording layers. The six recording layers are a first recording layer 411, a second recording layer 412, a third recording layer 413, a fourth recording layer 414, a fifth recording layer 415, and a sixth recording layer 416. The spacing between layers is about 5 μm. The cover layer thickness is about 75 μm. Each of the recording layers is composed of four stacked layers which are a reflection layer 61, an interference layer 62, an absorption layer 63, and an interference layer 64. This recording layer structure is designed, with an optical multiple interference effect taken into consideration, to have the reflectivity at the backside of each of the recording layers suppressed by the interference layers and the absorption layer.

Table 5 shows example reflectivities and transmittances designed for the recording layers of a multilayered optical recording medium.

TABLE 5

| | | | | | Effective |
|---|---|---|---|---|---|
| | Reflectivity | Reflectivity | | Two-way | (composite) |
| | from the | from the | Transmittance | transparency | reflectivity at |
| | incident side 51 | backside 52 | 53 | to the layer | the layer |
| The 1st | 3.0% | 0.5% | 90.0% | 100.0% | 3.0% |
| recording | | | | | |
| layer 411 | | | | | |
| The 2nd | 3.7% | 0.6% | 88.0% | 81.0% | 3.0% |
| recording | | | | | |
| layer 412 | | | | | |
| The 3rd | 4.8% | 0.8% | 83.0% | 62.7% | 3.0% |
| recording | | | | | |
| layer 413 | | | | | |
| The 4th | 6.9% | 1.2% | 75.0% | 43.2% | 3.0% |
| recording | | | | | |
| layer 414 | | | | | |
| The 5th | 12.3% | 2.1% | 60.0% | 24.3% | 3.0% |
| recording | | | | | |
| layer 415 | | | | | |
| The 6th | 34.3% | 5.7% | 0.0% | 8.8% | 3.0% |
| recording | | | | | |
| layer 416 | | | | | |

The design method for designing a recording layer structure having such optical characteristics is similar to design methods commonly used in designing phase change recording media used to manufacture rewritable optical discs such as DVD-RWs. Namely, the thicknesses of the four thick-film layers are designed to be optimum parameters for suppressing the backside reflectivity of the recording layer, achieving a target reflectivity for the incident side of the recording layer, and maximizing the transmittance of the recording layer. In this example, the reflection layer is made of a silver-based alloy, the two interference layers are made of AnS—SiO2, and the absorption layer is made of a chalcogenide material. In the present embodiment, the effective reflectivity (excluding the effect of the light incident side 42) at the optical head has been designed to be about 3%. Based on this, Table 6 shows, for each of the third to the sixth recording layers, the effective reflectivity of light returning to the optical head after being reflected at the backside of the upper second recording layer, the intensity proportion of the returning light (crosstalk ratio) relative to the signal light, and the effect of interference with optical wave interference taken into consideration.

TABLE 6

| | Reflectivity of | | | |
|---|---|---|---|---|
| | unwanted | | | |
| | light at the | | | |
| | backside of | | | Effect of |
| | upper second | Crosstalk | Effect of | interference |
| | layer | ratio | interference | (dB) |
| The 1st | — | — | — | — |
| recording | | | | |
| layer 411 | | | | |
| The 2nd | — | — | — | — |
| recording | | | | |
| layer 412 | | | | |
| The 3rd | 0.0006% | 0.02% | 1.36% | −37.3 |
| recording | | | | |
| layer 413 | | | | |
| The 4th | 0.0009% | 0.03% | 1.71% | −35.4 |
| recording | | | | |
| layer 414 | | | | |
| The 5th | 0.0016% | 0.06% | 2.35% | −32.6 |
| recording | | | | |
| layer 415 | | | | |
| The 6th | 0.0044% | 0.15% | 3.83% | −28.3 |
| recording | | | | |
| layer 416 | | | | |

As shown, crosstalk intensity ratios of 0.15% or less have been obtained. The effect of crosstalk even with interference taken into consideration is about 3.8% (about −28 dB) or less. The values are small enough for practical purposes.

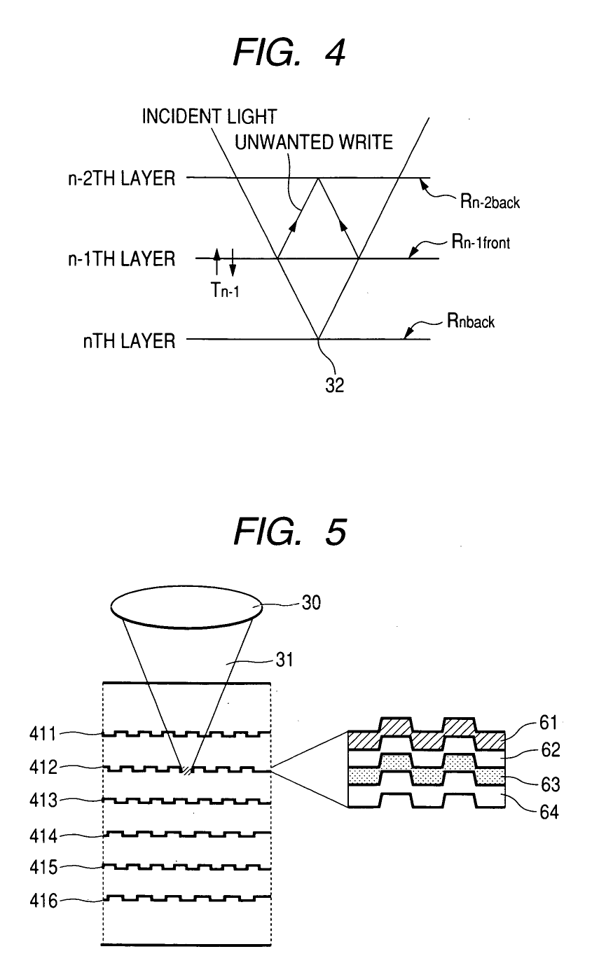

The effective reflectivities of unwanted light shown in Table 6 are each equal to, with reference to FIG. 4:

(Rn−1 front)×(Rn−2 back)×(Rn−1 front)×(two-way transmittance to immediately before the n−1th layer)

With reference to Table 5, the effective reflectivity of signal light is set to be about 3% for both the nth layer and the n−1th layer. The effective reflectivity at the n−1th layer, for example, is equal to:

(Rn−1 front)×(two-way transmittance to immediately before the n−1th layer)

Hence, its proportion to the reflectance of unwanted light (crosstalk ratio) is equal to:

(Rn−1 front)×(Rn−2 back)

Therefore, as described in the “SUMMARY OF THE INVENTION,” in terms of any two adjacent recording layers excluding the one farthest from the light incident surface with the one, out of the two adjacent recording layers, closer to the light incident surface being referred to as the first recording layer and the other being referred to as the second recording layer, the crosstalk ratio can be reduced by making the product of the optical reflectivities at the backside and at the front side, respectively, of the second recording layer adequately small. When the interference as described above is taken into consideration, the crosstalk ratio is required to be 0.25% or lower, that is, equal to or lower than the square of the amplitude ratio, 1/20, between the maximum density and minimum density reproduced signals. To make its effect on the reproduced signal negligible, the crosstalk ratio is desired to be not higher than the square of 1/30, that is, 0.1% or lower.

Tables 7 and 8 show, for comparison purposes, corresponding values designed in a conventional case involving equal reflectivity for the backside and the incident side of each recording layer.

TABLE 7

| | | | | | Effective |
|---|---|---|---|---|---|
| | Reflectivity | Reflectivity | | Two-way | (composite) |
| | from the | from the | Transmittance | transparency | reflectivity at |
| | incident side 51 | backside 52 | 53 | to the layer | the layer |
| The 1st | 3.0% | 3.0% | 90.0% | 100.0% | 3.0% |
| recording | | | | | |
| layer 411 | | | | | |
| The 2nd | 3.7% | 3.7% | 88.0% | 81.0% | 3.0% |
| recording | | | | | |
| layer 412 | | | | | |
| The 3rd | 4.8% | 4.8% | 83.0% | 62.7% | 3.0% |
| recording | | | | | |
| layer 413 | | | | | |
| The 4th | 6.9% | 6.9% | 75.0% | 43.2% | 3.0% |
| recording | | | | | |
| layer 414 | | | | | |
| The 5th | 12.3% | 12.3% | 60.0% | 24.3% | 3.0% |
| recording | | | | | |
| layer 415 | | | | | |
| The 6th | 34.3% | 34.3% | 0.0% | 8.8% | 3.0% |
| recording | | | | | |
| layer 416 | | | | | |

TABLE 8

| | Reflectivity of | | | |
|---|---|---|---|---|
| | unwanted | | | |
| | light at the | | | |
| | backside of | | | Effect of |
| | upper second | Crosstalk | Effect of | interference |
| | layer | ratio | interference | (dB) |
| The 1st | — | — | — | — |
| recording | | | | |
| layer 411 | | | | |
| The 2nd | — | — | — | — |
| recording | | | | |
| layer 412 | | | | |
| The 3rd | 0.0006% | 0.02% | 1.36% | −37.3 |
| recording | | | | |
| layer 413 | | | | |
| The 4th | 0.0009% | 0.03% | 1.71% | −35.4 |
| recording | | | | |
| layer 414 | | | | |
| The 5th | 0.0016% | 0.06% | 2.35% | −32.6 |
| recording | | | | |
| layer 415 | | | | |
| The 6th | 0.0044% | 0.15% | 3.83% | −28.3 |
| recording | | | | |
| layer 416 | | | | |

As shown, the crosstalk intensity ratio is about 0.8%, and the effect of crosstalk with interference taken into consideration is about 9% (about −20 dB) or less. Thus, the effect of crosstalk is great.

### Third Embodiment

To grasp the quality of a multilayered optical recording medium, it is necessary to evaluate the effect of crosstalk on each recording layer individually. In a multilayered optical recording medium, however, crosstalk, particularly, the crosstalk caused by back reflection forms an unwanted optical spot on an untargeted layer as shown in FIG. 4. It is difficult to isolate the effect of such crosstalk in a detection instrument. This is because light reflected from the optical spot formed by the incident light and light reflected from an optical spot formed by unwanted light return to an optical head through approximately identical paths. The present embodiment provides a signal isolation method in which each of multiple layers is provided with a unique signal.

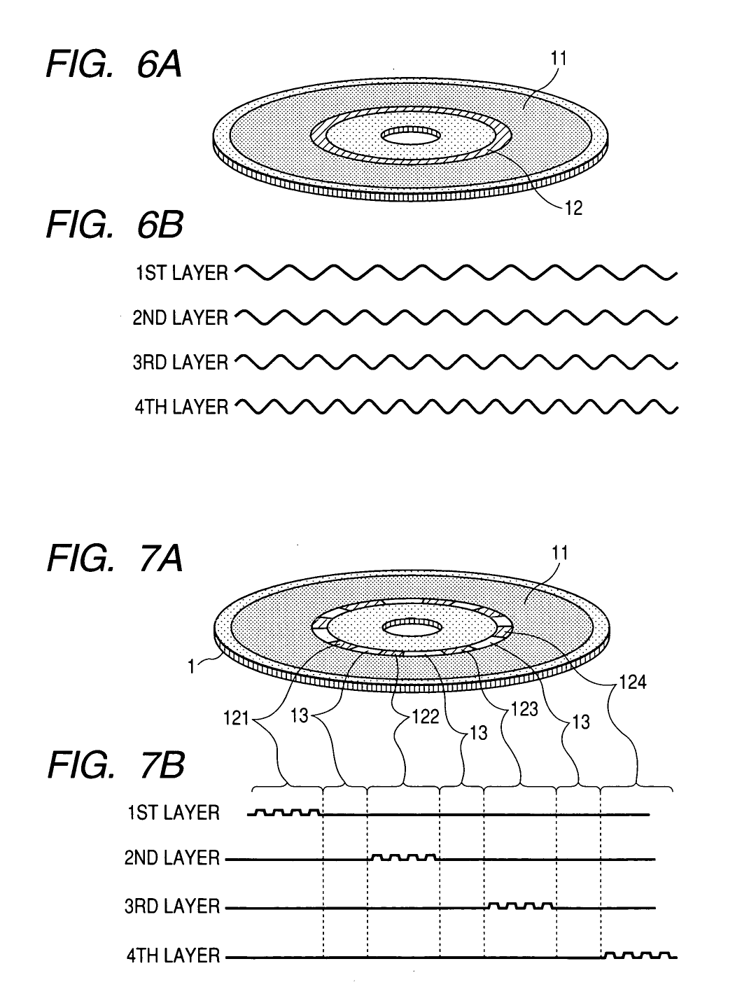

As shown in FIG. 6A, a layer identification signal area is provided in an inner radial area of a recording medium 1. In the area, different signals as shown in FIG. 6B are recorded on different layers. The difference in signal frequency between layers is small. Within each of the layers, the signal frequencies are approximately identical. With such different signals recorded on the different layers, source layers of unwanted signals can be easily identified. For frequency isolation, a bandpass filter or a spectrum analyzer may be used.

Even though, in the present embodiment, a radial area for recording single-frequency signals is provided, single-frequency signals may be superimposedly embedded at wobble addresses without using any special area so that layer identification is possible over the whole recording area. An advantage of using single-frequency signals is that, even in a state in which neither focus servo nor tracking servo is effected, when an optical spot crosses layers, layer identifying signals can be detected with high sensitivity.

### Fourth Embodiment

FIG. 7 shows another embodiment of an arrangement for identifying and evaluating interlayer crosstalk. In the arrangement shown in FIG. 7, plural areas in each of which a signal is recorded only on one layer are provided in a portion of an optical recording disc with none of the plural areas overlapping with another. In this case, it is important to provide a no-signal area between signal-recorded areas by taking spread of convergent light into consideration.

An advantage of this method is that, in a state in which focus has been set on a layer, the effect of crosstalk from other layers can be observed with ease. In this case, single-frequency signals need not necessarily be recorded, but, from a viewpoint of detection sensitivity, it is desirable to use a repetition signal of one type or another. In this method, too, it is possible, as in the third embodiment, to record single-frequency signals in a signal area and evaluate the effect of crosstalk without effecting focusing or tracking. In that case, however, it is necessary to sample layer identification signals in synchronization with disc rotation.

### Fifth Embodiment

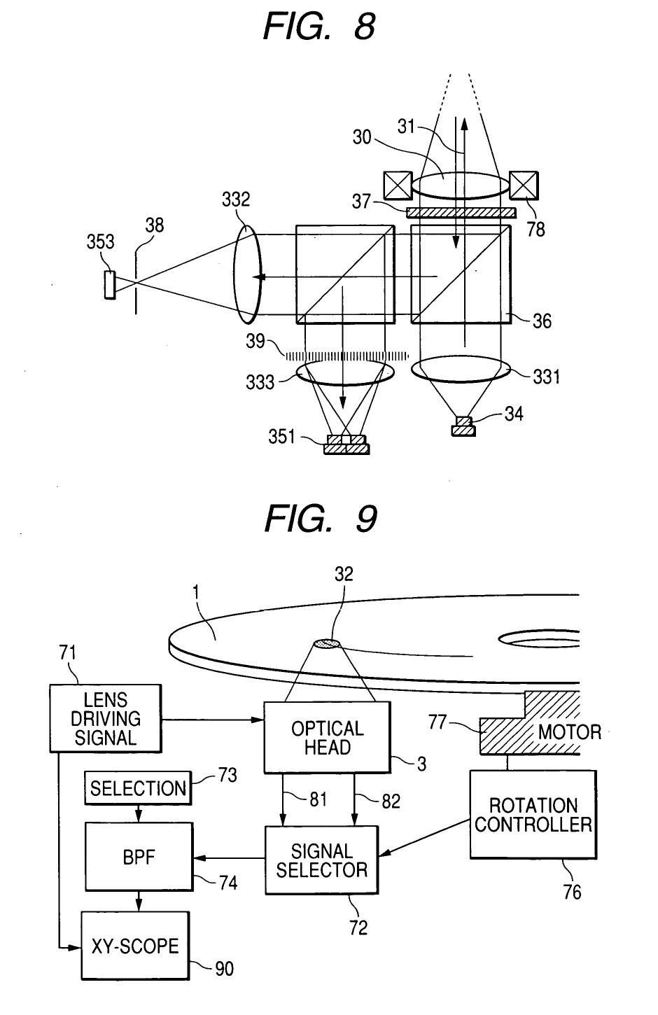

In this embodiment, to evaluate the effect of crosstalk from the backsides of other layers, an optical head with a configuration as shown in FIG. 8 is used. The configuration is designed to isolate, without failure, signals reflected directly from other layers. Namely, a so-called con-focal configuration is used in which a servo signal detection section and a reproduced signal detection section are isolated, and a pinhole is provided immediately in front of a detector included in the reproduced signal detection section. In this configuration, the light reflected directly from other layers is prevented from entering the detector.

FIG. 9 shows an evaluation system configured using an optical head 3 having a configuration as described above. A lens 30 of the optical head 3 is moved up and down by a ramp-shaped lens driving signal 71. When an optical spot 32 crosses layers, a detector 353 detects signals corresponding to the layers. The frequencies of the detected signals are sorted using a band-pass filter 74 and observed using an XY scope 90. In this arrangement, signal frequency components of different layers measured with respect to the lens position as a horizontal axis can be observed individually. A signal selection circuit 72 samples signals with a sampling time of several tens of microseconds in synchronization with a rotation control circuit 76. This makes it possible to prevent horizontal axis deviations attributable to vertical deviations of a disc. This system is compatible with the discs of the third and the fourth embodiments, too. The signal selection circuit can accept both an ordinary sum signal 82 and a wobble signal (difference signal) 81.

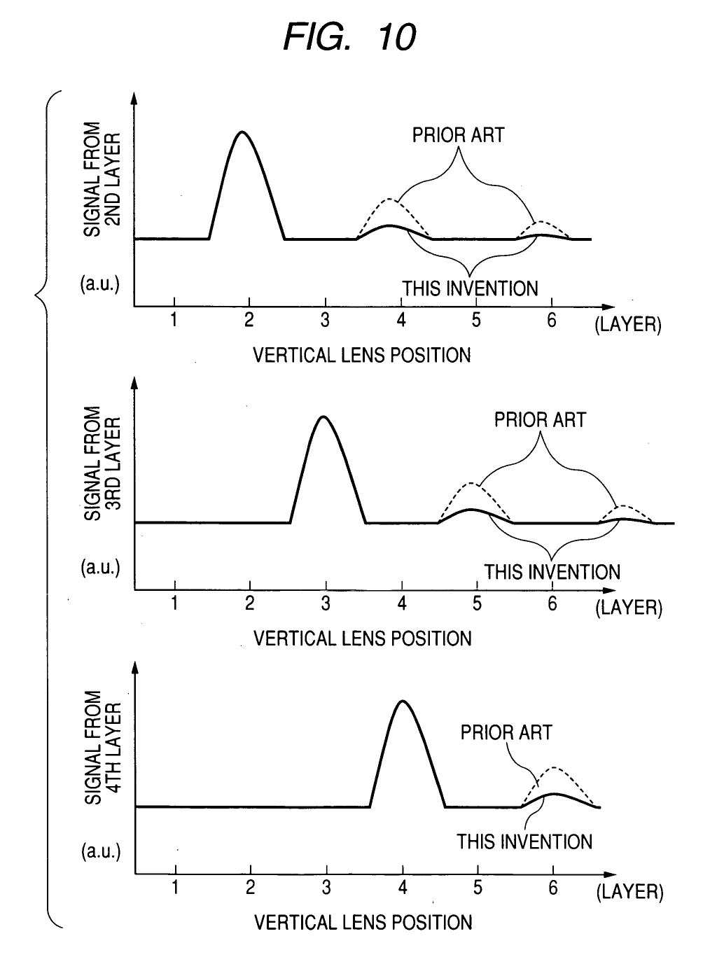

In FIG. 10, the crosstalk characteristics, shown in Tables 5 and 6, of the optical recording medium according to the second embodiment of the present invention and the crosstalk characteristics, shown in Tables 7 and 8, of a prior-art optical recording medium are evaluated layer by layer. For this evaluation, the wobble-superimposed layer identification signals of the third embodiment have been superimposed on the address information on each layer. As shown in FIG. 10, according to the evaluation results on the optical recording medium of the present invention, the second peak representing crosstalk in the curve of the signal component on each layer is adequately low, whereas comparatively large second and third peaks are observed for the prior-art optical recording medium.

### Sixth Embodiment

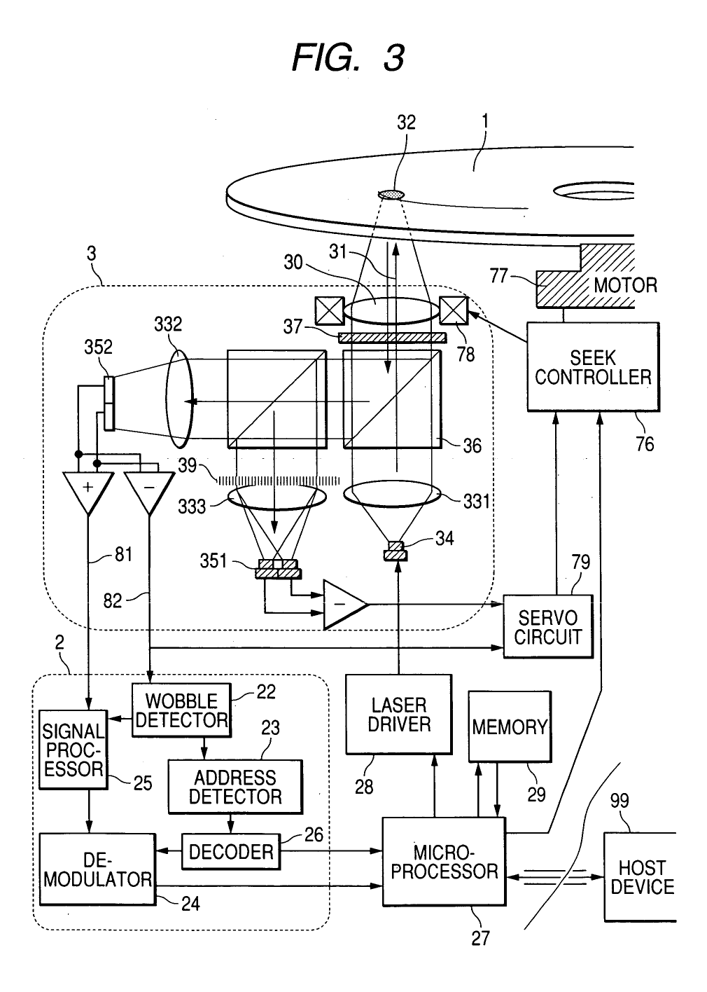

Next, an example of evaluating reproduction from various optical discs using a recording/reproducing device as shown in FIG. 3 will be described. Light emitted from a laser 34 (with a wavelength of about 405 nm in the present embodiment) included in the optical head 3 passes through a collimator lens 331 to be collimated into an approximately parallel optical beam. The optical beam having been collimated advances through a beam splitter 36. The optical beam is then emitted as convergent light 31 on an optical disc 1 through an aberration compensation device 37 and an objective lens 30, and forms a spot 32. The light reflected from the disc is guided to advance through the beam splitter 36 and a hologram device 39, and led by detection lenses 333 and 332 to a servo detector 351 and a signal detector 352, respectively. Signals outputted from the detectors 351 and 352 are, after being processed for addition or subtraction, inputted to a servo circuit 79 as servo signals such as a track error signal and a focus error signal. Using the track error signal and the focus error signal, the servo circuit 79 controls the positions of an objective lens actuator 78 and the optical head 3 so as to position the optical spot 32 at a targeted read/write area. The detector 352 outputs an addition signal which is inputted to a signal reproduction block 2. The signal then undergoes filtering, frequency equalization, and digitalization in a signal processing circuit 25. Address information formed as wobble grooves on the disc is detected as a difference signal coming from the divided detector 352, and inputted to a wobble detection circuit 22 included in the signal reproduction block 2. The wobble detection circuit 22 generates a clock signal synchronized with the wobble signal and discriminates wobble waveform. The wobble signal detected by the wobble detection circuit 22 is converted into digital information by an address detection circuit 23. The digital information is then detected as address information after undergoing error correction by a decoding circuit 26. Based on the address information thus detected, a start timing signal for read/write processing is generated. The start timing signal thus generated is used to control a user data demodulation circuit 24. At the same time, the address information is also sent to a control circuit (microprocessor) 27 for use as access information.

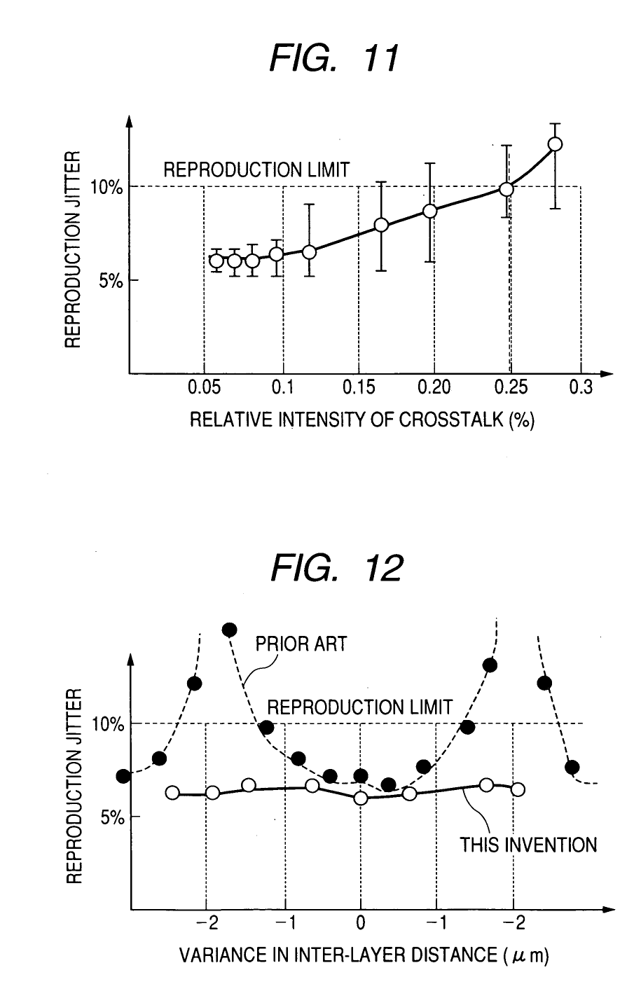

An example of evaluating, made using the present apparatus, the quality (jitter) of a signal reproduced from a multilayered optical recording medium will be described in the following. To clarify the effect of the present invention, plural media with reflectivities intentionally made different from those described in Table 5 were prepared, and the amounts of crosstalk induced in the media were measured by the method of the fifth embodiment. FIG. 11 shows the measurement results evaluated using the quality (jitter) of reproduced signals as a parameter. As shown, jitter measurement variation starts increasing as the relative intensity of crosstalk exceeds about 0.1%. A reproduction limit is reached when the relative intensity of crosstalk exceeds 0.25%, i.e. one four-hundredth. It is due to interference that the jitter measurement variation increases when the relative intensity of crosstalk reaches 0.1%. When interference occurs, even a variance in interlayer distance of only about one half the wavelength can cause large signal variation. As a result, measurement variation sharply increases.

FIG. 12 shows results of reproduction jitter evaluation made on the fifth layer of each of optical recording media configured (as per Table 1 used in describing the first embodiment) according to the present invention and optical recording media having a prior-art configuration (as per Table 3 used in describing the first embodiment) including varied interlayer distances. As shown in FIG. 12, jitter measured in the media according to the present invention was adequately low regardless of variance in interlayer distance. In the prior-art media, on the other hand, even a small variance in interlayer distance caused reproduction jitter to sharply increase. The prior art medium with an optimum variance (zero) in interlayer distance had unequal interlayer distances, namely, 5 μm, 7 μm, 5 μm, and 9 μm as arranged from the light incident side. In the media according to the present invention, the interlayer distance was uniform, i.e. 6 μm as in the medium of the first embodiment. The evaluation results indicate that, compared with the prior-art media, the media according to the present invention are less affected by variances in interlayer distance. This means that they can be manufactured with a greater margin of specifications.

Even though the preferred embodiments have been described centering on reproduction characteristics, the mechanism in which the reduction in reflectivity from the backsides of layers made possible by the present invention reduces the deterioration of read/write characteristics attributable to interlayer interference can be used also for recordable media and rewritable media.

Even though the present embodiment has been described by way of jitter evaluation, a method of recording or reproducing information to or from a medium according to the present invention using a recording and/or reproducing device as shown in FIG. 3 also constitutes an embodiment of the present invention.

What is claimed is:

1. A multilayered optical recording medium comprising three or more recording layers, wherein optical reflectivity of at least one recording layer is smaller at a backside thereof than at a front side thereof as viewed from a side on which light for recording or reproducing is incident.

2. The optical recording medium according to claim 1, wherein optical reflectivity of every recording layer excluding two layers farthest from the incident side is smaller at a backside thereof than at a front side thereof.

3. A multilayered optical recording medium comprising three or more recording layers, wherein a product of optical reflectivity at a backside of a first recording layer and optical reflectivity at a front side of a second recording layer is 0.0025 or smaller, the first recording layer being one of any two adjacent recording layers excluding one farthest from a light incident side and being closer to the light incident side than the other of the any two adjacent recording layers, and the second recording layer being the other of the any two adjacent recording layers.

4. The optical recording medium according to claim 3, wherein the product of the optical reflectivity at the backside of the first recording layer and the optical reflectivity at the front side of the second recording layer is 0.001 or smaller.

5. The multilayered optical recording medium according to claim 3, wherein, relative to a signal output detected by light reflected from any recording layer on which a focal optical spot is positioned, a proportion of a maximum value of a crosstalk signal from the recording layer detected at a location to which the focal optical spot has been moved from the recording layer is 0.0025 or smaller.

6. The optical recording medium according to claim 5, wherein the proportion of the maximum value of the crosstalk signal is 0.001 or smaller.

7. The optical recording medium according to claim 1, wherein, when a focal optical spot is moved on the medium having an area where different signals are recorded on different recording layers, relative to a maximum intensity of a signal on any of the recording layers, a proportion of a second peak output of the signal detected at a location to which the focal optical spot has been moved from the any of the recording layers is 0.0025 or smaller.

8. The optical recording medium according to claim 7, wherein the proportion of the second peak output is 0.001 or smaller.

9. The optical recording medium according to claim 7, wherein the different signals recorded on the different recording layers differ from one another in frequency.

10. The optical recording medium according to claim 7, wherein the signals recorded on the recording layers are wobble signals formed in grooves or in series of pits.

11. The multilayered optical recording medium according to claim 1, wherein, when a focal optical spot is moved on the medium having an area where a signal is recorded on only one recording layer with no signal recorded on other recording layers, relative to a maximum intensity of a signal on the one recording layer, a proportion of a second peak output of the signal detected at a location to which the focal optical spot has been moved from the one recording layer is 0.0025 or smaller.

12. The optical recording medium according to claim 11, wherein the proportion of the second peak output is 0.001 or smaller.

13. A method for evaluating an optical recording medium, comprising:
pre-recording a signal with a constant frequency on each of a plurality of recording layers of an optical recording medium, the constant frequency being different between the plurality of the recording layers;
isolating and detecting a frequency signal component from each of the plurality of the recording layers;
moving a focal optical spot across the plurality of the recording layers; and
determining an amount of crosstalk from each of the plurality of the recording layers by measuring a proportion, relative to a maximum intensity of the frequency signal component of each of the plurality of the recording layers, of a sub-peak output.

14. A method for reproducing information, wherein, using a multilayered optical recording medium comprising three or more recording layers with optical reflectivity of at least one recording layer being smaller at a backside thereof than at a front side thereof as viewed from a side on which light for recording or reproducing is incident, information recorded on the one recording layer is reproduced by irradiating the recording layer with the light.

15. A method for recording information, wherein, using a multilayered optical recording medium comprising three or more recording layers with optical reflectivity of at least one recording layer being smaller at a backside thereof than at a front side thereof as viewed from a side on which light for recording or reproducing is incident, information is recorded on the one recording layer by irradiating the recording layer with the light.
